(19) United States
(12) Patent Application Publication
(10) Pub. No.: US 2007/0135566 A1
(43) Pub. Date: Jun. 14, 2007

(54) Viscosity-reduced sprayable compositions

(75) Inventors: Nadya Belcheva, Middletown, CT (US); Ahmad R. Hadba, Wallingford, CT (US)

Correspondence Address: UNITED STATES SURGICAL,;A DIVISION OF TYCO HEALTHCARE GROUP LP, 195 MCDERMOTT ROAD, NORTH HAVEN, CT, 06473, US

(73) Assignee: Tyco Healthcare Group LP

(21) Appl. No.: 11/636,222

(22) Filed: Dec. 8, 2006

Related U.S. Application Data
(60) Provisional application No. 60/748,393, filed on Dec. 8, 2005.

(51) Int. Cl. C08G 18/08

(52) U.S. Cl. 524/589

(57) ABSTRACT

The present disclosure provides sprayable compositions having reduced viscosity which may be used as adhesives or tissue sealants.

### CROSS-REFERENCE TO RELATED APPLICATIONS

This application claims the benefit of U.S. Provisional Patent Application No. 60/748,393 filed Dec. 8, 2005, the entire disclosure of which is incorporated by reference herein.

### BACKGROUND

1. Technical Field

The present disclosure relates to sprayable compositions and more particularly to viscosity-reduced sprayable compositions, such as adhesives or tissue sealants.

2. Background of Related Art

In recent years there has developed increased interest in replacing or augmenting sutures with adhesive bonds. The reasons for this increased interest include: (1) the potential speed with which repair might be accomplished; (2) the ability of a bonding substance to effect complete closure, thus preventing seepage of fluids; and (3) the possibility of forming a bond without excessive deformation of tissue.

Studies in this area, however, have revealed that in order for surgical adhesives to be accepted by surgeons, they must possess a number of properties. They must exhibit high initial tack and an ability to bond rapidly to living tissue; the strength of the bond should be sufficiently high to cause tissue failure before bond failure; the adhesive should form a bridge, typically a permeable flexible bridge; and the adhesive bridge and/or its metabolic products should not cause local histotoxic or carcinogenic effects.

Several materials useful as tissue adhesives or tissue sealants are currently available. One type of adhesive that is currently available is a cyanoacrylate adhesive. However, cyanoacrylate adhesives can have a high flexural modulus which can limit their usefulness. Another type of tissue sealant that is currently available utilizes components derived from bovine and/or human sources. For example, fibrin sealants are available. However, as with any natural material, variability in the material can be observed.

It would be desirable to provide a fully synthetic biological adhesive or sealant that is flexible, biocompatible and highly consistent in its properties. It would also be desirable if the adhesive or sealant was of sufficiently low viscosity to be sprayed.

### SUMMARY

The present disclosure provides viscosity-reduced sprayable compositions and a method for making viscosity-reduced sprayable compositions. The viscosity-reduced sprayable compositions include a first component, a viscosity-reducing amount of a polar solvent, and optionally a second component. The first component may be mixed with the polar solvent to create a viscosity-reduced sprayable composition in the form of an emulsion or solution. Optionally, the emulsion or solution may be further mixed with a second component to also form a viscosity-reduced sprayable composition.

In embodiments, the sprayable compositions of the present disclosure may include a first component of the formula: 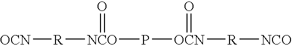
wherein P is a polyether, a polyester or a polyether-ester group and R is an aliphatic or aromatic group, in combination with a viscosity-reducing amount of a polar solvent, and an optional second component including at least one amine group.

In embodiments, the compositions of the present disclosure may include a first component of the formula: 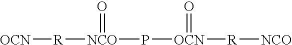
wherein P is a polyether-ester group and R is an aliphatic or aromatic group in combination with a viscosity-reducing amount of a polar solvent, wherein the ratio of the polar solvent to the first component is from about 1:0.25 to about 1:10 w/w, and the sprayable composition has a viscosity from about 5 cP to about 400 cP.

Methods for making compositions of the present disclosure are also provided. In embodiments, such methods may include mixing a first component of the formula: 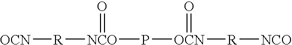
wherein P is a polyether, a polyester or a polyether-ester group, and R is an aliphatic or aromatic group, with a viscosity-reducing amount of a polar solvent to form an emulsion or solution. In embodiments, the emulsion or solution may then be combined with a second component having at least one amine group.

Tissue adhesives and/or sealants including the compositions of the present disclosure are also provided.

### DETAILED DESCRIPTION

The present disclosure relates to a sprayable composition for use as a tissue adhesive or sealant, which is biocompatible, non-immunogenic and biodegradable. The composition can be employed to adhere tissue edges, seal air/fluid leaks in tissues, adhere medical devices, i.e. implants, to tissue, and for tissue augmentation such as sealing or filling voids or defects in tissue. The sprayable composition can be applied to living tissue and/or flesh of animals, including humans.

While certain distinctions may be drawn between the usage of the terms “flesh” and “tissue” within the scientific community, the terms are used interchangeably herein as referring to a general substrate upon which those skilled in the art would understand the present sprayable composition to be utilized within the medical field for the treatment of patients. As used herein, “tissue” may include, but is not limited to, skin, bone, neuron, axon, cartilage, blood vessel, cornea, muscle, fascia, brain, prostate, breast, endometrium, lung, pancreas, small intestine, blood, liver, testes, ovaries, cervix, colon, stomach, esophagus, spleen, lymph node, bone marrow, kidney, peripheral blood, embryonic and/or ascite tissue.

The sprayable composition of the present disclosure includes a first component, a viscosity-reducing amount of a polar solvent, and optionally a second component. In embodiments, the optional second component includes at least one amine group.

In embodiments, the first component may be represented by the formula: 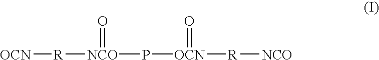
wherein P is a polyether, a polyester or a polyether-ester group; and R is an aromatic, aliphatic, or alicyclic group. Suitable polyethers which may be utilized are within the purview of those skilled in the art and include, for example, polyethylene glycol, polypropylene glycol, polybutylene glycol, polytetramethylene glycol, polyhexamethylene glycol, and combinations thereof. In a particularly useful embodiment the polyether is polyethylene glycol.

Suitable polyesters which may be utilized are within the purview of those skilled in the art and include, for example, trimethylene carbonate, ε-caprolactone, p-dioxanone, glycolide, lactide, 1,5-dioxepan-2-one, polybutylene adipate, polyethylene adipate, polyethylene terephthalate, and combinations thereof.

In addition, the first component may include a poly(ether-ester) block. Any suitable poly(ether-ester) block known to one skilled in the art may be utilized. Some examples include, but are not limited too, polyethylene glycol-polycaprolactone, polyethylene glycol-polylactide, polyethylene glycol-polyglycolide and various combinations of the individual polyethers and polyesters described herein. Additional examples of poly(ether-ester) blocks are disclosed in U.S. Pat. No. 5,578,662 and U.S. Patent Application No. 2003/0135238, the entire contents of each of which are incorporated by reference herein.

In addition to the polyether, polyester or poly(ether-ester) block, the first component may be endcapped with an isocyanate to produce a diisocyanate-functional compound. Suitable isocyanates for endcapping the aliphatic polyether, polyester or poly(ether-ester) block include aromatic, aliphatic and alicyclic isocyanates. Examples include, but are not limited to, aromatic diisocyanates such as 2,4-toluene diisocyanate, 2,6-toluene diisocyanate, 2,2′-diphenylmethane diisocyanate, 2,4′-diphenylmethane diisocyanate, 4,4′-diphenylmethane diisocyanate, diphenyldimethylmethane diisocyanate, dibenzyl diisocyanate, naphthylene diisocyanate, phenylene diisocyanate, xylylene diisocyanate, 4,4′-oxybis(phenylisocyanate) or tetramethylxylylene diisocyanate; aliphatic diisocyanates such as tetramethylene diisocyanate, hexamethylene diisocyanate, dimethyl diisocyanate, lysine diisocyanate, 2-methylpentane-1,5-diisocyanate, 3-methylpentane-1,5-diisocyanate or 2,2,4-trimethylhexamethylene diisocyanate; and alicyclic diisocyanates such as isophorone diisocyanate, cyclohexane diisocyanate, hydrogenated xylylene diisocyanate, hydrogenated diphenylmethane diisocyanate, hydrogenated trimethylxylylene diisocyanate, 2,4,6-trimethyl 1,3-phenylene diisocyanate or commercially available DESMODURS® from Bayer Material Science.

Methods for endcapping the polyether, polyester or poly(ether-ester) block with a diisocyanate are within the purview of those skilled in the art. In some embodiments, the polyether, polyester or poly(ether-ester) block may be combined with a suitable diisocyanate, in embodiments a toluene diisocyanate, and heated to a suitable temperature from about 55° C. to about 75° C., in embodiments from about 60° C. to about 70° C., in embodiments about 65° C. In some embodiments the resulting diisocyanate-functional compound may then be obtained by hot extraction with petroleum ether.

The viscosity of the first component may be from about 10 cP to about 500,000 cP, in embodiments from about 100 cP to about 200,000 cP, typically from about 200 cP to about 100,000 cP.

It has been discovered that by reducing the viscosity of the first component, the resulting sprayable composition takes less time to cure and forms a more uniform film than higher viscosity sprayable components. Also, the first component is more easily mixed with the optional second component.

In embodiments, the first component may be mixed with a viscosity-reducing amount of a polar solvent. Suitable polar solvents which may be utilized are within the purview of those skilled in the art and include, for example, water, alcohols such as ethanol, triethylene glycol, methoxy-polyethylene glycols, dimethylformamide, dimethylacetamide, gamma-butyrolactone, N-methylpyrrolidone, ketones such as methylethyl ketone, cyclohexanone, ethers such as diethyl ether, and combinations of these and other polar solvents.

The polar solvent may be mixed with the first component at a ratio of from about 1:0.25 to about 1:10 w/w, in embodiments at a ratio of from about 1:1 to about 1:4 w/w.

The mixture of the first component and polar solvent as described herein may result in an emulsion or a diluted solution. The viscosity of the resulting emulsion or solution may be below about 400 cP, in embodiments below about 200 cP. In some embodiments, the viscosity of the resulting emulsion or solution may be from about 5 cP to about 400 cP, in other embodiments from about 25 cP to about 300 cP, in still other embodiments from about 50 cP to about 150 cP. The decreased viscosity improves the spraying of the emulsion or solution without sacrificing the adherence and physico-mechanical properties of the composition as an adhesive, sealant or drug delivery system.

In addition to the polar solvents described herein, it is envisioned that the first component may also be mixed with polar drugs. As with the polar solvent, the polar drugs may react with the first component and produce an emulsion or solution with a reduced viscosity. The first component may be mixed with the polar drug and optionally a second component in situ to form synthetic drug delivery systems. Any suitable polar drug within the purview of those skilled in the art may be used.

The optional second component comprises at least one amine group. Suitable compounds containing at least one amine group which may be utilized are within the purview of those skilled in the art and include, for example, diamines, such as ethylenediamine, N-ethylethylenediamine and N,N′-diethylethylenediamine and alkanolamines. Examples of alkanolamines include dihydric and trihydric alkanolamines, such as ethanolamine and N-ethylethanolamine. Other amines which may be utilized include triethylenediamine, N-methylmorpholine, pentamethyl diethylenetriamine, dimethylcyclohexylamine, tetramethylethylenediamine, 1-methyl-4-dimethylaminoethyl-piperazine, 3-methoxy-N-dimethyl-propylamine, N-ethylmorpholine, diethylethanolamine, N-cocomorpholine, N,N-dimethyl-N′,N′-dimethylisopropyl-propylene diamine, N,N-diethyl-3-diethyl aminopropylamine, dimethyl-benzyl amine, and combinations thereof.

In embodiments, the second component may be mixed with the emulsion or solution comprising the first component and the viscosity-reducing amount of a polar solvent at a ratio of from about 1:10 to about 10:1 w/w, in embodiments, at a ratio of from about 5:1 to about 1:1 w/w.

The first component and the viscosity-reducing polar solvent may be mixed with the optional second component in any manner within the purview of those skilled in the art. One example includes keeping the emulsion or solution including the first component and polar solvent separate from the optional second component and spraying the individual ingredients in a consecutive manner onto the same location, thereby allowing the two ingredients to mix and form a bond in situ. Another example includes keeping the emulsion or solution including the first component and polar solvent separate from the optional second component and spraying the two ingredients simultaneously through the same nozzle, thereby allowing the two ingredients to mix while being sprayed.

Various modifications and variations of the embodiments described herein will be apparent to those skilled in the art from the foregoing detailed description. Such modifications and variations are intended to come within the scope of the following claims.

What is claimed is:

1. A sprayable composition comprising:
a first component of the formula: 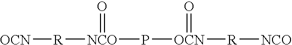
wherein P is a polyether, a polyester or a polyether-ester group; and R is an aliphatic or aromatic group;
a viscosity-reducing amount of a polar solvent; and
an optional second component comprising at least one amine group.

2. The sprayable composition of claim 1 wherein P is a polyether selected from the group consisting of polyethylene glycol, polypropylene glycol, polybutylene glycol, polytetramethylene glycol, polyhexamethylene glycol, and combinations thereof.

3. The sprayable composition of claim 1 wherein P is a polyester selected from the group consisting of trimethylene carbonate, ε-caprolactone, p-dioxanone, glycolide, lactide, 1,5-dioxepan-2-one, polybutylene adipate, polyethylene adipate, polyethylene terephthalate, and combinations thereof.

4. The sprayable composition of claim 1 wherein the polar solvent is selected from the group consisting of water, ethanol, triethylene glycol, methoxy-polyethylene glycols, dimethylformamide, dimethylacetamide, gamma-butyrolactone, N-methylpyrrolidone, methylethol ketone, cyclohexanone, diethyl ether, and combinations thereof.

5. The sprayable composition of claim 1 wherein the optional second component is selected from the group consisting of ethylenediamine, N-ethylethylenediamine, N,N′-diethylethylenediamine, ethanolamine, N-ethylethanolamine, triethylenediamine, N-methylmorpholine, pentamethyl diethylenetriamine, dimethylcyclohexylamine, tetramethylethylenediamine, 1-methyl-4-dimethylaminoethyl-piperazine, 3-methoxy-N-dimethyl-propylamine, N-ethylmorpholine, diethylethanolamine, N-cocomorpholine, N,N-dimethyl-N′,N′-dimethylisopropyl-propylene diamine, N,N-diethyl-3-diethyl aminopropylamine, dimethyl-benzyl amine, and combinations thereof.

6. The sprayable composition of claim 1 wherein the ratio of the polar solvent to the first component is from about 1:0.25 to about 1:10 w/w, and the sprayable composition has a viscosity from about 5 cP to about 400 cP.

7. The sprayable composition of claim 1 wherein the ratio of the polar solvent to the first component is from about 1:1 to about 1:4 w/w, and the sprayable composition has a viscosity from about 25 cP to about 300 cP.

8. A tissue sealant comprising the sprayable composition of claim 1.

9. A method of producing a sprayable composition comprising the steps of:
mixing a first component of the formula: 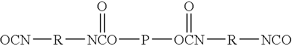
wherein P is a polyether, a polyester or a polyether-ester group, and R is an aliphatic or aromatic group, with a viscosity-reducing amount of a polar solvent to form an emulsion or solution.

10. The method of producing a sprayable composition of claim 9 wherein P is a polyether selected from the group consisting of polyethylene glycol, polypropylene glycol, polybutylene glycol, polytetramethylene glycol, polyhexamethylene glycol, and combinations thereof.

11. The method of producing a sprayable composition of claim 9 wherein P is a polyester selected from the group consisting of trimethylene carbonate, ε-caprolactone, p-dioxanone, glycolide, lactide, 1,5-dioxepan-2-one, polybutylene adipate, polyethylene adipate, polyethylene terephthalate, and combinations thereof.

12. The method of producing a sprayable composition of claim 9 wherein the polar solvent is selected from the group consisting of water, ethanol, triethylene glycol, methoxy-polyethylene glycols, dimethylformamide, dimethylacetamide, gamma-butyrolactone, N-methylpyrrolidone, methylethol ketone, cyclohexanone, diethyl ether, and combinations thereof.

13. The method of producing a sprayable composition of claim 9 wherein the ratio of the polar solvent to the first component is from about 1:0.25 to about 1:10 w/w, and the emulsion or solution has a viscosity from about 5 cP to about 400 cP.

14. The method of producing a sprayable composition of claim 9 wherein the ratio of the polar solvent to the first component is from about 1:1 to about 1:4 w/w, and the emulsion or solution has a viscosity from about 25 cP to about 300 cP.

15. The method of producing a sprayable composition of claim 9 further comprising the step of mixing the emulsion or solution with a second component comprising at least one amine group.

16. The method of producing a sprayable composition of claim 15 wherein the step of mixing the emulsion or solution with a second component comprising at least one amine group comprises a second component selected from the group consisting of ethylenediamine, N-ethylethylenediamine, N,N′-diethylethylenediamine, ethanolamine, N-ethylethanolamine, triethylenediamine, N-methylmorpholine, pentamethyl diethylenetriamine, dimethylcyclohexylamine, tetramethylethylenediamine, 1-methyl-4-dimethylaminoethyl-piperazine, 3-methoxy-N-dimethyl-propylamine, N-ethylmorpholine, diethylethanolamine, N-cocomorpholine, N,N-dimethyl-N′,N′-dimethylisopropyl-propylene diamine, N,N-diethyl-3-diethyl aminopropylamine, dimethyl-benzyl amine, and combinations thereof.

17. A sprayable composition comprising:
a first component of the formula: 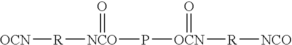
where P is a polyether-ester group and R is an aliphatic or aromatic group; and
a viscosity-reducing amount of a polar solvent,
wherein the ratio of the polar solvent to the first component is from about 1:0.25 to about 1:10 w/w, and the sprayable composition has a viscosity from about 5 cP to about 400 cP.

18. The sprayable composition of claim 17 wherein the polar solvent is selected from the group consisting of water, ethanol, triethylene glycol, methoxy-polyethylene glycols, dimethylformamide, dimethylacetamide, gamma-butyrolactone, N-methylpyrrolidone, methylethol ketone, cyclohexanone, diethyl ether, and combinations thereof.

19. The sprayable composition of claim 17 wherein the ratio of the polar solvent to the first component is from about 1:1 to about 1:4 w/w, and the emulsion or solution has a viscosity from about 25 cP to about 300 cP.

20. The sprayable composition of claim 17, further comprising a second component selected from the group consisting of ethylenediamine, N-ethylethylenediamine, N,N′-diethylethylenediamine, ethanolamine, N-ethylethanolamine, triethylenediamine, N-methylmorpholine, pentamethyl diethylenetriamine, dimethylcyclohexylamine, tetramethylethylenediamine, 1-methyl-4-dimethylaminoethyl-piperazine, 3-methoxy-N-dimethyl-propylamine, N-ethylmorpholine, diethylethanolamine, N-cocomorpholine, N,N-dimethyl-N′,N′-dimethylisopropyl-propylene diamine, N,N-diethyl-3-diethyl aminopropylamine, dimethyl-benzyl amine, and combinations thereof.
